(19) United States
(12) Patent Application Publication
(10) Pub. No.: US 2009/0309906 A1
(43) Pub. Date: Dec. 17, 2009

(54) INKJET APPLICATION DEVICE, MULTI-LAYERED INFORMATION RECORDING MEDIUM, AND METHOD OF PRODUCING THE MEDIUM

(76) Inventors: Masahiko Tsukuda, Osaka (JP); Morio Tomiyama, Nara (JP); Yuuko Tomekawa, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/307,642

(22) PCT Filed: Jun. 28, 2007
(86) PCT No.: PCT/JP2007/063002

§ 371 Date: Jan. 6, 2009

(30) Foreign Application Priority Data
Jul. 10, 2006 (JP) 2006-189224

(51) Int. Cl. B41J 25/308; B41J 29/38

(52) U.S. Cl. 347/8; 347/16

(57) ABSTRACT

An inkjet coating device, which applies a radioactive-ray curable resin to a subject, while moving either the subject or an inkjet head relative to the other, includes an inkjet head provided with an inkjet unit having an inkjet nozzle for ejecting droplets of the radioactive-ray curable resin and a radioactive-ray irradiation unit that is placed on the rear side of the inkjet unit in a moving direction relative to the subject so as to be spaced therefrom with a predetermined distance, and irradiates the radioactive-ray curable resin coated onto the subject with radioactive rays; and a driving unit that moves the inkjet head relative to the subject.

### BACKGROUND OF THE INVENTION

1. Technical Field

This invention relates to an information recording medium for use in reproducing or recording/reproducing information and a method for manufacturing such a medium. In particular, the present invention relates to a multi-layered information recording medium having information recording layers of two or more layers and a method for manufacturing such a medium.

2. Background Art

In recent years, studies have been made on an optical information recording system, and the optical information recording system has been widely used for industrial and household purposes. In particular, optical information recording media capable of recording information in high density, such as Compact Discs (CD) and Digital Versatile Discs (DVD), have come into wide use. Such optical information recording media have a structure in which on a transparent substrate with concave/convex pattern signals, such as pits representing information signals and guide grooves used for tracking a recording/reproducing light, formed thereon, a metal thin film, a thin-film material capable of being thermally recorded, and the like are stacked, and a protective layer is further formed thereon. The protective layer is made from a resin layer, a transparent substrate or the like, used for protecting the metal thin film, the thin-film material or the like from moisture and the like in the atmosphere. The reproducing process of information is carried out by irradiating the metal thin film and the thin-film material with a laser light so that a change in light quantity of the reflected light or the like is detected.

In the case of a CD, it is manufactured such a way that a metal thin film or a thin-film material or the like is stacked on a resin substrate having a thickness of about 1.1 mm on one of the sides of which a concave/convex pattern representing information signals is formed, and thereafter coated with an ultraviolet-ray curable resin or the like so that a protective layer is formed thereon. Here, a reproducing process of the information signals is carried out by allowing a laser light to be made incident not from the protective layer side, but from the substrate side.

Moreover, in the case of a DVD, it is manufactured such a way that after a metal thin film or a thin-film material or the like is stacked on a concave/convex patterned surface of a resin substrate having a thickness of about 0.6 mm, a resin substrate having a thickness of about 0.6 mm, prepared separately, is bonded thereto by using an ultraviolet-ray curable resin or the like. There have been strong demands for large capacities in the optical information recording medium, and in the DVD or the like, the information layer has been formed into multiple layers, and an optical information recording medium having a two-layered structure, in which signal layers, each made from a concave/convex pattern signal, a metal thin film, a thin-film material and the like, are formed with an intermediate layer having a thickness of several ten μms interposed therebetween, has been proposed.

In recent years, along with the wide use of digital hi-vision broadcasting, there have been strong demands for a new-generation optical information recording medium having a higher density and a larger capacity than those of the DVD. For example, a large-capacity recording medium such as a Blu-ray disc, in which on a concave/convex patterned surface of a substrate having a thickness of 1.1 mm, a metal thin film or the like is stacked, with a protective layer having a thickness of about 0.1 mm further formed thereon, has been proposed. In comparison with the DVD, the Blu-ray disc has a narrower track pitch of an information layer formed by a concave/convex pattern and also has smaller-size pits. For this reason, the spot of a laser light used for executing a recording/reproducing operation for information needs to be finely focused on the information layer. In the Blu-ray disc, a violet-blue laser light having a short wavelength of 405 nm is used as the laser light, and at the same time, an optical head that uses an objective lens having a numerical aperture (NA) of 0.85 as its objective lens for focusing the laser light is used. By using this optical head, the spot of the laser light is finely focused on the information layer. However, as the spot becomes smaller, the apparatus becomes more vulnerable to influences from the tilt of the disc, aberration tends to occur in a beam spot when the disc is tilted even only a little. When the aberration occurs in the beam spot, a distortion occurs in the focused beam, making it impossible to carry out a recording/reproducing operation. Therefore, in the Blu-ray disc, this disadvantage is compensated for by making the thickness of the protective layer on the laser light-incident side as thin as 0.1 mm.

Incidentally, also in the next generation information recording medium having a large capacity such as the Blu-ray disc, it has been proposed to provide a large capacity in the storage capacity by forming the information layer into a multi-layered structure in the same manner as in the DVD.

FIG. 2 is a cross-sectional view showing a two-layered Blu-ray disc having two information recording layers.

This two-layered Blu-ray disc has a structure in which on a molded resin substrate 201 with a first information face 202 formed on one face thereof as a concave/convex pattern, a metal thin film or a thin-film material capable of being thermally recorded is stacked so that a first information recording layer 203 is formed. A resin intermediate layer 204 that is virtually transparent to a recording/reproducing light is formed on the first information recording layer 203, and a second information face 205 made of a concave/convex pattern is formed on the resin intermediate layer 204. On the second information face 205, a metal thin film that is semi-transparent to the recording/reproducing light or a thin-film material capable of being thermally recorded is stacked so that a second information recording layer 206 is formed. Then, a protective layer 207 coated with a resin that is virtually transparent to the recording/reproducing light is formed so as to cover the second recording layer 206. This two-layered Blu-ray disc is designed so that recording, reproducing and the like of signals are executed by allowing a laser light to be made incident from the protective layer 207 side so as to be focused on the information recording layer for use in recording/reproducing of the first information recording layer and the second information recording layer. Here, the thickness of the molded resin substrate 201 is set to about 1.1 mm, the thickness of the resin intermediate layer is set to about 25 μm, and the thickness of the protective layer 207 is set to about 75 μm.

Here, the term “virtually transparent” mentioned here means to have a transmittance of about 90% or more relative to a recording/reproducing light, and the term “semi-transparent” means to have a transmittance of 10% or more to 90% or less relative to the recording/reproducing light.

In general, the method for producing such a multi-layered Blu-ray disc is carried out as follows. For example, the following description will discuss a method for producing a two-layered Blu-ray disc.

First, a molded resin substrate is prepared. The molded resin substrate is molded by using a resin-molding method such as an injection-molding method by using a metal stamper. In most cases, a material such as polycarbonate, which is superior in moldability, is used as the substrate material. Thereafter, a stacking process of a resin layer is carried out by using a forming process of a resin layer using a spin coating method or the like, as shown in Patent Document 1.

FIGS. 4A to 4I are drawings showing manufacturing processes of a two-layered disc including manufacturing processes of a resin intermediate layer and a protective layer by the use of a spin coating method.

(a) A mold resin substrate 401 having a thickness of about 1.1 mm is formed by using a resin molding method such as an injection molding method using a metal stamper. This molded resin substrate 401 has a first information face formed by pits having a concave/convex pattern and guide grooves formed on one surface thereof.
(b) Next, on the first information face, a metal thin film and a thin-film material capable of being thermally recorded are formed by using a sputtering method, a vapor deposition method or the like so that a first information recording layer 402 is formed.
(c) The molded resin substrate 401 on which this first information recording layer is formed is secured onto a rotation stage 403 by using a vacuum suction method or the like (FIG. 4A).
(d) Onto the first information recording layer 402 formed on the molded resin substrate 401 secured to the rotation stage 403, a radioactive-ray curable resin A404 is coated within a desired radius in a manner so as to form a concentric circle by using a dispenser (FIG. 4B).
(e) Thereafter, by spinning the rotation stage 403, the radioactive-ray curable resin A404 is stretched to form a resin layer 406 (FIG. 4C). At this time, the thickness of the resin layer 406 is controlled into a desired thickness by arbitrarily setting the viscosity of the radioactive-ray curable resin A404, the number of revolutions of the spinning rotation, the rotation time and the ambient atmosphere in which the spinning rotation is carried out, such as a temperature and moisture.
(f) After the spinning rotation is stopped, the resin layer 406 is irradiated with radioactive rays from a radioactive-ray irradiation device 405 to be cured.

Next, a resin layer 411 is formed on a transfer stamper 407.

(a) The transfer stamper 407 used for forming a second information face is formed by an injection-molding method by use of a metal stamper.
(b) This transfer stamper 407 is secured onto the rotation stage 408 through vacuum suction or the like.
(c) Onto the transfer stamper 407 secured to the rotation stage 408, a radioactive-ray curable resin B409 is coated within a desired radius in a manner so as to form a concentric circle by using a dispenser (FIG. 4D).
(d) Next, by spinning the rotation stage 408, the radioactive-ray curable resin B409 is stretched to form a resin layer 411 (FIG. 4E). The thickness of the resin layer 411 is controlled into a desired thickness as described earlier.
(e) After the spinning rotation is stopped, the resin layer 411 is irradiated with radioactive rays from a radioactive-ray irradiation device 410 to be cured.

Next, the resin layer 411 having the second information face is transferred onto the molded resin substrate 401 from the transfer stamper 407.

(a) On the rotation stage 413, the molded resin substrate 401 and the transfer stamper 407 with the respective resin layers 406 and 411 formed thereon are superposed, with a radioactive-ray curable resin C412 interposed therebetween, so that the respective resin layers 405 and 411 are made face to face with each other (FIG. 4F).
(b) Next, by spinning the rotation stage 413 with the molded resin substrate 401 and the transfer stamper 407 being integrated with each other, the radioactive-ray curable resin C is stretched so that a resin layer 414 having a desirably controlled thickness is formed.
(c) Next, the radioactive-ray curable resin C412 is irradiated with radioactive rays emitted from a radioactive-ray irradiation device 415 to be cured (FIG. 4G). The molded resin substrate 401 and the transfer stamper 407 are integrally formed with each other by the radioactive-ray curable resin C412.
(d) Thereafter, the transfer stamper 407 is peeled from the radioactive-ray curable resin B411 along the interface between the transfer stamper 407 and the radioactive-ray curable resin B411. Thus, the second information face is formed on the molded resin substrate 401 (FIG. 4H).
(e) On this second information face, a metal thin film, a thin-film material capable of being thermally recorded and the like are film-formed by a sputtering method, a vapor deposition method or the like so that a second information recording layer 416 is formed.
(f) Thereafter, by applying a radioactive-ray curable resin D thereto by a spin coating method in the same manner and irradiating it with radioactive rays to be cured, a protective film 417 is formed (FIG. 4I). Depending on cases, a hard coat layer or the like used for preventing defects on the protective layer surface due to scratches and adhesion of finger prints may be formed on the protective layer.

In this manner, a two-layered Blu-ray disc is completed.

Here, a material having good adhesive property to the first information recording layer 402 and the radioactive-ray curable resin C414 is used as the radioactive-ray curable resin A404 used herein. A material having good peeling property to the transfer stamper 407 and good adhesive property to the radioactive-ray curable resin C414 is used as the radioactive-ray curable resin B411. Moreover, those materials that are virtually transparent to wavelengths of recording/reproducing lights are used as the radioactive-ray curable resins A, B, C and D. Moreover, herein, the above description has been given to manufacturing processes of resin intermediate layers using three kinds of radioactive-ray curable resins; however, an easier method may be used in which the kinds of the radioactive-ray curable resins are reduced by controlling the peeling property or the like to the radioactive-ray curable resin through selection and the like of the material for the transfer stamper.

Moreover, as a method for forming the resin layer, not only the spin coating method described herein, but also a screen-printing method or the like has been proposed (JP-A No. 2002-092969). In this method, only the forming process of the radioactive-ray curable resin layer is changed from the spin coating method to the screen printing method, and virtually the same processes are carried out on the other processes.

### SUMMARY OF THE INVENTION

Upon forming the resin intermediate layer by using the spin coating method, however, a resin supply is sometimes given only to a specific area. Moreover, the centrifugal force to be utilized for stretching differs depending on radial positions. Because of these factors, a problem arises in which it becomes difficult to form the radioactive-ray curable resin with an even thickness. Moreover, since the resin reaches the outer circumferential edge face of the molded resin substrate, another problem arises in which the resin layer is projected along the outermost circumferential portion due to the influence of surface tension of the edge face. Furthermore, the spin coating method is easily influenced by irregularities on the coated surface. For example, upon manufacturing a multi-layered recording medium having three or four information recording layers, or upon forming a protective layer, the spin coating process is carried out on a resin intermediate layer preliminarily formed. In this case, since influences of irregularities on a plurality of the resin intermediate layers are accumulated, the evenness of the thickness might further deteriorate.

Moreover, in the case when the spin coating method is used, it takes about 10 seconds to apply a radioactive-ray curable resin at one time, and this causes a main reason for a reduction in the production efficiency in the manufacturing processes of a multi-layered recording medium. Moreover, in the case of the spin coating method, since a resin layer is formed while one portion of the resin dropped on the substrate is being spun off, it is necessary to drop more resin than the amount of resin that is required for the resin intermediate layer to be actually formed on the substrate. Furthermore, the resin that has been spun off from the substrate is abolished as it is, or needs to be directed to a new process such as a recycling process so as to be reused. The disposal of this spun-off resin also causes a main reason for a reduction in the production efficiency.

In the forming process of the resin intermediate layer by using the screen-printing method, it is possible to easily form an even thickness in comparison with the spin coating method. In contrast, since the screen printing method causes the screen to contact with the information recording layer or the information face of the transfer stamper upon application, a problem arises in which scratches or dusts are directly or indirectly caused on the information recording layer. Moreover, in the screen-printing method, since the resin is supplied only through pores opened in the screen, another problem arises in which air bubbles tend to be mingled in portions to which no resin is supplied. Furthermore, also in the screen-printing method, a mask needs to be placed so as to shield portions other than desired coating areas in order to apply the resin to the desired areas, and it becomes necessary to adjust mechanical position relative to the coating face with high precision. Moreover, also in the screen printing method, in the same manner as in the spin coating method, more resin than that required for the resin intermediate layer to be actually formed on the substrate needs to be supplied. The unused resin is abolished, or needs to be directed to a new process such as a recycling process so as to be reused. The disposal of this unused resin also causes a reason for a reduction in the production efficiency.

As one of methods for solving these problems relating to the spin coating method and the screen printing method, an coating technique by use of an inkjet method has been proposed in which an coating process can be carried out without the necessity of a special mask for use in a desired coating area and without any contact portions.

The inkjet method refers a technique for ejecting fine droplets having a volume in a range from about 1 pL to 1 nL, and the nozzle for use in ejecting is referred to as an inkjet nozzle. Various methods are known as the method for ejecting a resin, and the common fact is that since a structure for ejecting fine droplets through an inkjet nozzle having a small diameter is used, only a ejecting solution having a low viscosity can be ejected. Here, the expression “the ejecting solution has a low viscosity” indicates not the fact that the viscosity of a ejecting solution inside a liquid tank at a normal temperature is low, but the fact that resin viscosity on the periphery of the ejecting outlet of the inkjet nozzle is low. That is, in the inkjet method, it is necessary to set the resin viscosity on the periphery of the ejecting outlet to be a low viscosity. For example, a method in which the vicinity of the ejecting outlet of the inkjet nozzle is heated by a heater or the like so that the viscosity of the ejecting solution is lowered, and ejected or the like may be used. At present, in inkjet nozzles that are generally used or commercially available, the viscosity of a ejectable solution near the ejecting outlet is set in a range from several mPa·s to several ten mPa·s.

In the case where a resin intermediate layer is formed by using the inkjet method, since the resin having a low viscosity is ejected from the inkjet nozzle, a resin flow or the like tends to occur after the coat. For this reason, problems arise in which a projected resin occurs on the edge face of the coating area, or a protruded resin over a range wider than a desired coating area tends to occur. Moreover, since only the fine droplets having a volume from about 1 pL to 1 nL can be ejected as described earlier, another problem also arises in which it becomes very difficult to form an coated resin having a thickness, for example, exceeding 10 μm.

An object of the present invention is to solve the above problems with the inkjet method, to manufacture a resin intermediate layer having an even thickness, even in the case of a thickness, for example, exceeding 10 μm, and to provide a method for producing a multi-layered recording medium having good signal characteristics.

The present invention makes it possible to solve the above problems with the inkjet method by using the means described below. That is, the inkjet coating device in accordance with the present invention is an inkjet coating device, which applies a radioactive-ray curable resin to a subject, while moving either the subject or an inkjet head relative to the other, and it includes:

an inkjet head provided with an inkjet unit having an inkjet nozzle for ejecting droplets of the radioactive-ray curable resin and a radioactive-ray irradiation unit which is placed on the rear side of the inkjet unit in a moving direction relative to the subject so as to be spaced therefrom with a predetermined distance, and irradiates the radioactive-ray curable resin coated onto the subject with radioactive rays; and

a driving unit which moves the inkjet head relative to the subject.

With the above structure, it becomes possible to provide processes in which, while applying a radioactive-ray curable resin having a low viscosity by using an inkjet nozzle, the coated resin can be successively irradiated with radioactive rays to be cured after coat, and consequently to suppress the radioactive-ray curable resin having a low viscosity from flowing.

Moreover, the driving unit may move the inkjet head at a constant speed relative to the subject. In this case, after a predetermined period of time after the coat, the radioactive-ray curable resin coated to the subject from the inkjet nozzle can be sequentially irradiated with radioactive rays from the inkjet nozzle. Furthermore, the driving unit may move the inkjet head in a linear direction relative to the subject.

Furthermore, the inkjet head may be further provided with a radioactive-ray shielding plate interposed between the inkjet nozzle unit and the radioactive-ray irradiation unit so that the radioactive-ray shielding plate prevents radioactive rays emitted from the radioactive-ray irradiation unit from being irradiated before droplets of the radioactive-ray curable resin ejected from the inkjet nozzle are coated.

Moreover, the inkjet head may be provided with a first radioactive-ray irradiation unit and a second radioactive-ray irradiation unit which are placed on the front side and rear side in a relative moving direction, while the inkjet unit is interposed therebetween, with a predetermined distance apart from the inkjet unit.

Furthermore, the driving unit may move the inkjet head reciprocatingly in a linear direction relative to the subject, and upon inverting the relative moving direction, the inkjet unit may make a switch from the first radioactive-ray irradiation unit to the second radioactive-ray irradiation unit so as to be irradiated with radioactive rays.

Furthermore, the inkjet head may have a structure in which a plurality of inkjet nozzles are disposed on the inkjet nozzle unit over not less than the width of the subject in a direction perpendicular to the relative moving direction.

With this structure, the coat of the radioactive-ray curable resin can be carried out efficiently.

The method for producing a multi-layered information recording medium in accordance with the present invention is a method for producing a multi-layered information recording medium having a substrate, a plurality of information recording layers placed on the substrate, a resin intermediate layer disposed between the information recording layers and a protective layer formed on the information recording layer, wherein

by using an inkjet coating device including an inkjet head provided with an inkjet unit having an inkjet nozzle for ejecting droplets of a radioactive-ray curable resin and a radioactive-ray irradiation unit which is placed on the rear side of the inkjet unit in a moving direction relative to a subject so as to be spaced therefrom with a predetermined distance, and irradiates the radioactive-ray curable resin coated onto the subject with radioactive rays, the method includes coating and irradiation steps in which the radioactive-ray curable resin is dropped from the inkjet unit onto the subject, while being moved relative to the subject, and the radioactive-ray curable resin is then sequentially irradiated with radioactive rays from the radioactive-ray irradiation unit so that resin intermediate layers are formed on the subject.

With the above structure, it becomes possible to form a resin intermediate layer having an even thickness.

Moreover, in the coating and irradiation steps, the subject may be a substrate provided with an information recording layer. In this case, the method may further include a transfer step in which an information face is transferred to be formed onto the surface of the radioactive-ray curable resin formed on the substrate.

Furthermore, in the coat and irradiation steps, the subject may be a transfer stamper. In this case, the method further includes:

superposing the transfer stamper on the substrate with the radioactive-ray curable resin interposed therebetween; and

peeling the transfer stamper from the radioactive-ray curable resin.

Moreover, the coating and irradiation steps may include the steps of:

forming wall faces of an inner edge portion and an outer edge portion surrounding an area in which a resin intermediate layer having a predetermined coat thickness and made of a radioactive-ray curable resin is formed while a radioactive-ray curable resin is irradiated with radioactive rays after dropping the radioactive-ray curable resin onto the inner edge portion in a radial direction and the outer edge portion in the radial direction; and

forming the resin intermediate layer by irradiating the radioactive-ray curable resin with radioactive rays after dropping the radioactive-ray curable resin onto the area surrounded by the wall faces of the inner edge portion and the outer edge portion.

By using the above structure, the radioactive-ray curable resin is coated to an area surrounded by the wall faces of the inner edge portion and the outer edge portion so that, even when the resin has a flowing property, it is possible to achieve a resin intermediate layer having an even thickness.

Furthermore, in the coating and irradiation steps, the inkjet coating device may be moved at a constant speed relative to the subject so that after a lapse of a predetermined period of time from the coat of the radioactive-ray curable resin, the radioactive-ray curable resin is irradiated with radioactive rays.

Furthermore, the coating and irradiation steps may be carried out a plurality of times.

Furthermore, in the last step among the coating and irradiation steps of a plurality of times, the dose of the radioactive-ray irradiation may be made smaller in comparison with the dose in the preceding coating and irradiation steps.

Furthermore, in the last step among the coating and irradiation steps of a plurality of times, only the coat of the radioactive-ray curable resin may be carried out.

With the above structure, since the outermost surface of the radioactive-ray curable resin is allowed to have an uncured portion, a good transferring process of the information face can be achieved.

Moreover, in the coating and irradiation steps, a plurality of kinds of resins may be used as the radioactive-ray curable resin. With this structure, it is possible to form a resin intermediate layer in which a plurality of resins having different functions are stacked.

Furthermore, a multi-layered information recording medium in accordance with the present invention may be manufactured by using the above method for manufacturing a multi-layered information recording medium. Furthermore, this multi-layered information recording medium may have the resin intermediate layer whose edge face has a zig-zag shape caused by the droplets ejected from the inkjet nozzle. The edge face is formed into the zig-zag shape by use of the inkjet method.

In accordance with the present invention, an inkjet nozzle unit having an inkjet nozzle and a radioactive-ray irradiation unit are prepared, and the radioactive-ray irradiation unit is placed on the rear side of the inkjet nozzle unit used for relatively scanning the subject so that, while applying a radioactive-ray curable resin having a low viscosity by using an inkjet nozzle, the coated resin can be successively irradiated with radioactive rays to be cured, and it becomes possible to suppress the radioactive-ray curable resin having a low viscosity from flowing, and consequently to form a resin intermediate layer having an even thickness.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1, is a schematic view showing a structure of an inkjet coating device in accordance with first embodiment of the present invention, and at the same time, is a view showing one example of coating and irradiation steps by using the inkjet coating device;

FIG. 2 is a cross-sectional view showing a structure of a two-layered Blu-ray disc;

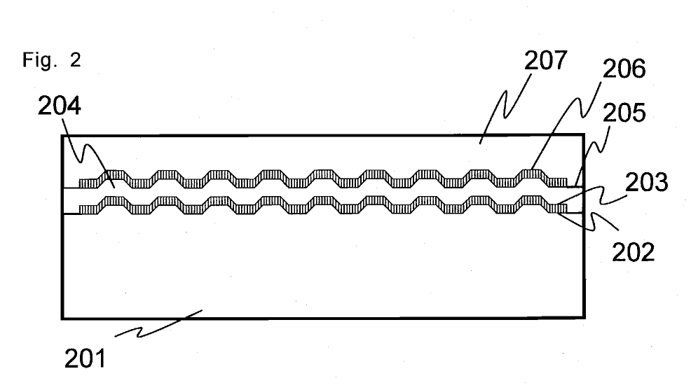

FIGS. 3A to 3F are views showing manufacturing steps of a metal stamper;

FIGS. 4A to 4I are views showing manufacturing steps of a two-layered disc including manufacturing steps of a resin intermediate layer by use of a spin coating method and a protective layer;

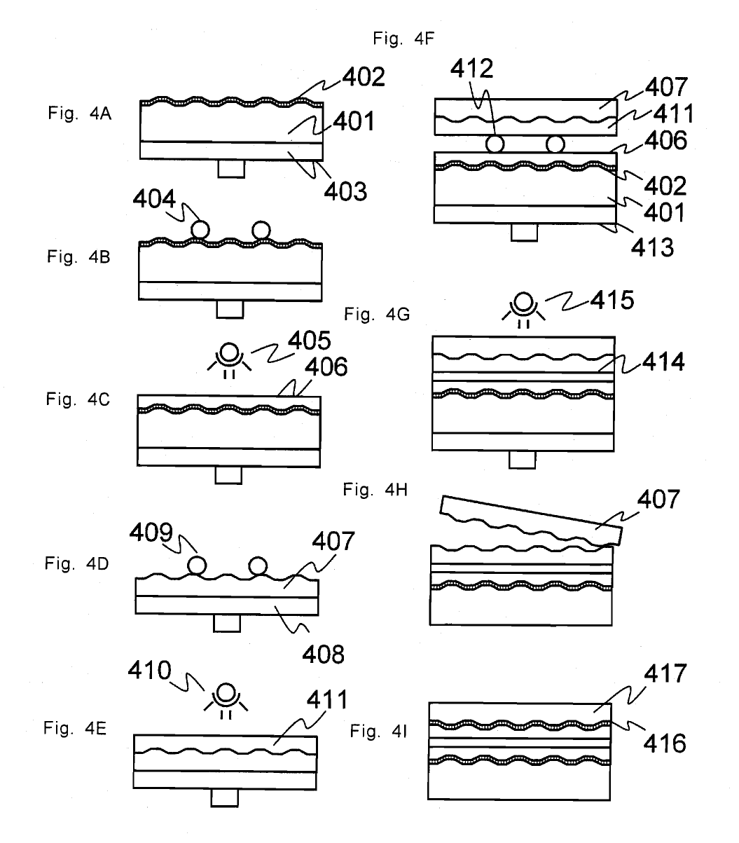

FIGS. 5A and 5B are cross-sectional views showing typical structural examples of an inkjet nozzle;

FIG. 6 is a cross-sectional view showing a structure of a multi-layered information recording medium in accordance with first embodiment of the present invention;

FIGS. 7A to 7C are views showing structural examples of an inkjet nozzle unit;

FIG. 8 is a view showing a structure of an inkjet nozzle unit in accordance with first embodiment of the present invention;

FIGS. 9A and 9B are views showing coating and irradiation steps of a plurality of times in accordance with first embodiment of the present invention;

FIGS. 10A to 10D are views showing one example of a transferring step of an information surface onto the resin intermediate layer in accordance with first embodiment of the present invention;

FIGS. 11A and 11B are views showing a relationship between a molded resin substrate and an inkjet nozzle unit; and

FIGS. 12A to 12C are views showing one example of coating and irradiation steps by use of an inkjet coating device in accordance with second embodiment of the present invention.

### DETAILED DESCRIPTION OF THE PREFERRED EMBODIMENTS

Referring to attached drawings, the following description will discuss a method for manufacturing an inkjet coating device and a multi-layered information recording medium in accordance with an embodiment of the present invention. Here, in the drawings, those members that are virtually the same are indicated by the same reference numerals.

### First Embodiment 1

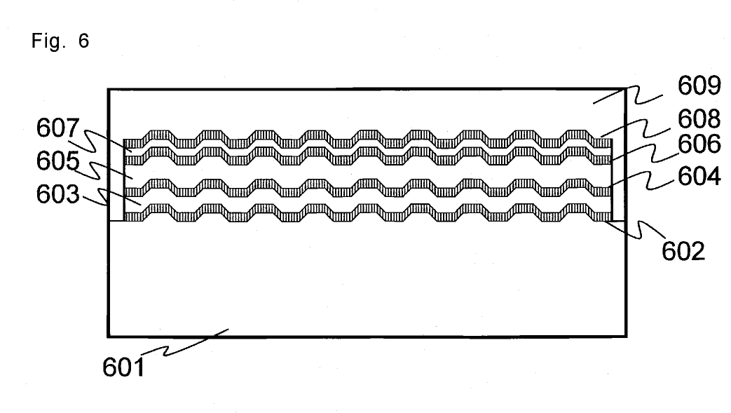

FIG. 6 is a cross-sectional view showing a structure of a multi-layered information recording medium in accordance with first embodiment of the present invention. This multi-layered information recording medium is a four-layered information recording medium that can be recorded and reproduced from one side. This four-layered information recording medium is formed by stacking four information recording layers on a molded resin substrate 601 with an information face of guide grooves having a concave/convex pattern being transferred and formed on one side face. This multi-layered recording medium is constituted by a first information recording layer 602, a first resin intermediate layer 603, a second information recording layer 604, a second resin intermediate layer 605, a third information recording layer 606, a third resin intermediate layer 607, a fourth information recording layer 608 and a protective layer 609 that are successively formed on the molded resin substrate 601. The first information recording layer 602 is disposed so as to be made in contact with a first information face formed on the molded resin substrate 601. The first resin intermediate layer 603 is stacked so as to be made in contact with the first information recording layer 602, with a second information face having a concave/convex pattern being formed on one of the faces. The second information layer 604 is disposed so as to be made in contact with the second information face. The second resin intermediate layer 605 is stacked so as to be made in contact with the second information recording layer 604, with a third information face having a concave/convex pattern being formed on one of the faces. The third information recording layer 606 is disposed so as to be made in contact with the third information face. The third resin intermediate layer 607 is stacked so as to be made in contact with the third information recording layer 606, with a fourth information face having a concave/convex pattern being formed on one of the faces. The fourth information recording layer 608 is disposed so as to be made in contact with the fourth information face. The protective layer 609 is formed so as to be made in contact with the fourth information recording layer 608.

This multi-layered information recording medium is characterized in that at least one of resin intermediate layers among the first resin intermediate layer 603, the second resin intermediate layer 605 and the third resin intermediate layer 607 is formed by applying a radioactive-ray curable resin thereon by using an inkjet coating device, which will be described later, and then irradiating with g radioactive rays. For this reason, the edge face of the resin intermediate layer has a zig-zag shape that depends on the size of droplets ejected from an inkjet nozzle.

The following description will discuss the respective constituent members of this multi-layered information recording medium.

### <Molded Resin Substrate>

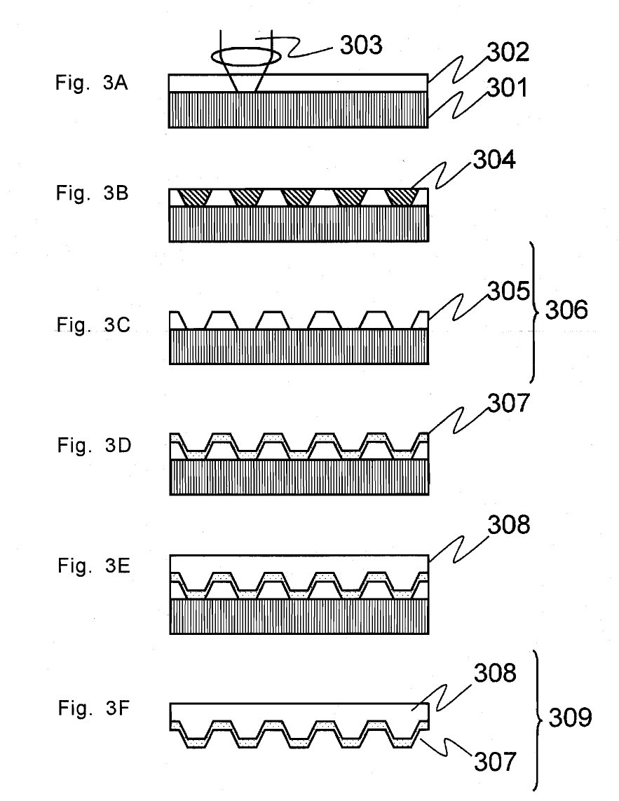

The molded resin substrate 601 may be formed by any substrate as long as it can support the information recording layers, resin intermediate layers and protective layer to be stacked thereon. Here, in order to provide a shape compatible with that of an optical disc such as a CD, DVD or a Blu-ray disc, the substrate is preferably formed into a disc shape having, for example, an outer diameter of φ 120 mm, a center-hole diameter of φ 15 mm and a thickness in a range from about 1.0 to 1.1 mm. Moreover, the molded resin substrate 601 is preferably formed by a polycarbonate or an acrylic resin. This molded resin substrate 601 has one side face on which an information face, such as guide grooves or the like having a concave/convex pattern, is formed by a resin molding process such as an injection-molding method by use of a metal stamper as shown in FIG. 3F. In the present first embodiment, this substrate is formed by using polycarbonate.

### <Manufacturing Step of Metal Stamper Used for Manufacturing Molded Resin Substrate>

FIGS. 3A to 3F are schematic views showing manufacturing steps of the stamper that is a metal mold used for manufacturing a molded resin substrate for an information recording medium.

(a) First, a photosensitive material such as photoresist is coated onto an original substrate 301 made of a glass disc, a silicon wafer or the like, to form a photosensitive film 302 thereon.
(b) Next, by using an exposing beam 303, such as a laser light beam or an electron beam, a pattern of pits, guide grooves or the like is exposed (FIG. 3A). Thus, a latent image made of exposure portions 304 is formed (FIG. 3B).
(c) Thereafter, when removing the exposure portions 304 by use of an alkali developing solution or the like, a recording original disc 306 on which a concave/convex shaped pattern 305 is formed on the original disc 301 by the photosensitive member is obtained (FIG. 3C).
(d) A conductive thin film 307 is formed on the surface of the recording original disc 306 by using a sputtering method, a vapor deposition method or the like (FIG. 3D).
(e) A metal plate 308 is formed by metal plating or the like by using the conductive thin film 307 as electrodes.
(f) Next, the conductive film 307 and the metal plate 308 are peeled from each other along an interface between the photosensitive film 302 and the conductive thin film 307. Furthermore, the residual photosensitive material on the surface of the conductive film 307 is removed by using a removing member or the like. Thereafter, its is subjected to a punch-out molding process so as to have inner and outer diameters fitted to a molding machine so that a metal stamper 309 serving as a metal mold used for molding the molded resin substrate is manufactured (FIG. 3F).

### <First Information Recording Layer>

In the case where the information recording medium is a reproduction-dedicated medium, the first information recording layer 602 is designed so as to have at least a characteristic for reflecting reproducing light. For example, the layer is formed by depositing a reflective material containing, for example, Al, Ag, Au, Si, SiO₂, TiO₂ or the like using a method such as a sputtering method and a vapor deposition method. Moreover, in the case where the information recording medium is a recordable medium, since information needs to be written therein by irradiating with recording light, the layer may include at least a layer made of a phase-changeable material such as, for example, GeSbTe, or a recording material containing an organic pigment, for example, phthalocyanine or the like. Furthermore, if necessary, the layer may contain another layer, such as a reflective layer or an interface layer, for improving recording/reproducing characteristics. The second information recording layer 604, the third information recording layer 606 and the fourth information recording layer 608 may be formed in the same manner. However, since the recording/reproducing operation is carried out by allowing recording/reproducing light to be made incident on the respective information recording layers from the protective layer 609 side, the layers from the first information recording layer to the fourth information recording layer are preferably constituted so as to have gradually higher transmittances relative to recording/reproduction light.

### <First Resin Intermediate Layer>

The first resin intermediate layer 603 may be formed by using a resin that is virtually transparent to the recording/reproducing light, for example, a radioactive-ray curable resin, such as an ultraviolet-ray curable resin mainly made from acrylic resin, or an epoxy-based ultraviolet-ray curable resin. The term “virtually transparent” referring herein means that the layer has a transmittance of 90% or more relative to the wavelength of the recording/reproducing light, and materials having a transmittance of 95% or more are furthermore preferable.

The method for manufacturing the first resin intermediate layer 603 includes the steps of:

(a) applying a liquid-state radioactive-ray curable resin onto the first information recording layer 602 by using an inkjet coating device, which will be described later, and irradiating with radioactive rays; and
(b) transferring the information face onto the surface of the radioactive-ray curable resin by utilizing a transfer stamper having an information face including pits, guide grooves and the like.

### <Transfer Stamper>

First, the transfer stamper 1004 will be described.

The transfer stamper 1004 is made from a polyolefin material that is a material exerting good peeling property to the radioactive-ray curable resin, and its thickness is made thinner than that of the molded resin substrate, such as, for example, 0.6 mm. This arrangement is made so that upon peeling the transfer stamper from the molded resin substrate having a thickness of about 1.1 mm, by utilizing a difference in rigidity derived from different thicknesses of the substrates, the transfer stamper is warped so as to be peeled therefrom. In the same manner as in the molded resin substrate, the polyolefin material is a material where an information face such as pits, guide grooves and the like having a concave/convex pattern is easily formed on one side by using a method such as an injection-molding method by using a conventional metal stamper or the like. Moreover, since the polyolefin material has a high transmittance to radioactive rays such as ultraviolet rays, the radioactive-ray curable resin can be effectively cured by irradiating with radioactive rays through the transfer stamper. Furthermore, since the polyolefin material has only small adhesive strength to the cured radioactive-ray curable resin, it can be easily peeled from the interface to the radioactive-ray curable resin after the curing process. A center hole is formed in the center of the transfer stamper 1004 so as to adjust eccentricity relative to the molded resin substrate 1001 through the center boss 1005.

### <Transferring Step Using Transfer Stamper>

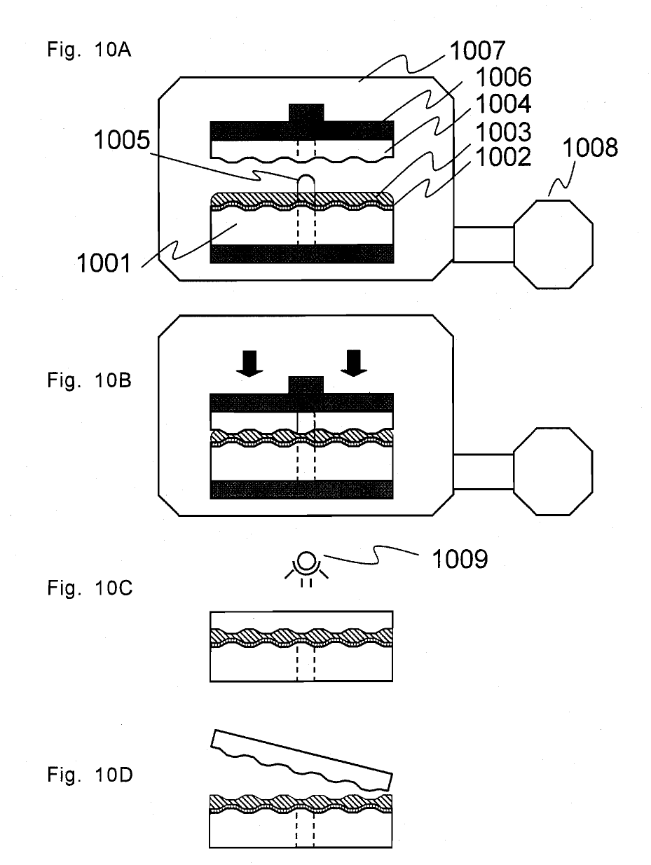

FIGS. 10A to 10D are views showing one example of a transferring step of the information face onto the resin intermediate layer in first embodiment of the present invention.

(a) A molded resin substrate 1001 to which a radioactive curable resin 1001 has been completely coated is transported into a vacuum chamber 1007. At this time, the transfer stamper 1004 is also disposed inside the vacuum chamber 1007 (FIG. 10A).
(b) The inside of the vacuum chamber 1007 is evacuated by a vacuum pump 1008 such as a rotary pump or a turbo molecular pump to make a vacuum atmosphere.
(c) When the pressure inside the vacuum chamber 1007 is reached a vacuum degree of 100 Pa or less, the transfer stamper 1004 is superposed on the molded resin substrate 1001 (FIG. 10B). At this time, a pressurizing plate 1006, placed on the upper portion of the transfer stamper 1004, presses the transfer stamper 1004 so that the information face on the transfer stamper is transferred onto the radioactive-ray curable resin 1003. Since the vacuum chamber is in the vacuum atmosphere, no air bubbles are mingled between the radioactive-ray curable resin 1003 and the transfer stamper 1004 so that the two members can be properly bonded to each other.
(d) The molded resin substrate 1001 and the transfer stamper 1004 thus bonded to each other are irradiated with radioactive rays through the transfer stamper 1004 by a radioactive-ray irradiation device 1009, inside the vacuum chamber, or after having been taken out (FIG. 10C).
(e) Thereafter, by driving a wedge between the transfer stamper 1004 and the molded resin substrate 1001, or by blowing compressed air therebetween, the transfer stamper 1004 is peeled from the interface between the radioactive-ray curable resin and the transfer stamper (FIG. 10D). Thus, the first resin intermediate layer with the information face transferred thereon is formed.

Here, in addition to the material described above, another different material, such as metal, may be used as the transfer stamper 1004. Moreover, a resin intermediate layer made of two or more resin layers may be formed by using two kinds or more of radioactive-ray curable resins. Furthermore, the radioactive-ray curable resin may be irradiated with radioactive rays from the molded resin substrate side. Various methods for transferring the information face onto the radioactive-ray curable resin are proposed, and any method may be used without limiting the effects of the present invention.

Moreover, the second resin intermediate layer 605 and the third resin intermediate layer 607 may be formed by using the same method as that of the first resin intermediate layer 603.

### <Protective Layer>

The protective layer 609 is preferably made to be virtually transparent to recording/reproducing light. For example, a radioactive-ray curable resin, such as an ultraviolet-ray curable resin mainly made from acrylic resin, or an epoxy-based ultraviolet-ray curable resin, may be used. The term “virtually transparent” referring herein means that the layer has a transmittance of 90% or more relative to the wavelength of the recording/reproducing light, and materials having a transmittance of 95% or more are furthermore preferable.

Various techniques, such as a spin coating method, a screen printing method, a gravure printing method and an inkjet method, are proposed as the forming method of the protective layer 609. The same technique as the above manufacturing method of the resin intermediate layer is preferably used as the forming method of the protective layer 609. For example, in the case where the resin intermediate layer is coated by using an inkjet method, the formation of the protective layer is most preferably carried out by using the inkjet method. Moreover, with respect to the forming method of the protective layer, not limited to the coating method of the radioactive-ray curable resin, and a sheet-shaped material made from, for example, a polycarbonate resin, an acrylic resin and the like may be bonded to form the protective layer, with an adhesive or the like interposed therebetween.

### <Thicknesses of Respective Layers>

Moreover, in the multi-layered information recording medium in first embodiment of the present invention, a violet blue laser beam having a wavelength of 405 nm is used, and the beam is focused onto the respective information layers from the protective layer 609 side, with an objective lens having an NA of 0.85 being coated, so that a recording/reproducing operation is carried out. In order to alleviate influences from the tilt of the disc, the thickness from the surface of the protective layer 609 to the first information recording layer 602 is set to about 0.1 mm.

Moreover, the thickness of the protective layer 609 is preferably set to about 40 μm or more so as to alleviate influences given to recording/reproducing characteristics of the respective information recording layers due to dusts adhered to the surface of the protective layer, scratches or the like. More preferably, the thickness is set to 50 μm or more.

Moreover, the thicknesses of the first resin intermediate layer, the second resin intermediate layer and the third resin intermediate layer are preferably set to respectively different thicknesses so as to alleviate influences of crosstalk or interference from other layers. In this case, the respective thicknesses are set to about 15 μm, about 20 μm and about 10 μm. Moreover, the thickness of the protective layer is set to about 55 μm. However, the designed value of the thickness of each resin intermediate layer is one example, and another designed value of the thickness may be used without causing any change in the effects of the present invention.

As briefly mentioned in the above description about the outline of the structure and the manufacturing method of the multi-layered information recording medium of first embodiment of the present invention, the method for producing the multi-layered information recording medium of the present invention is characterized in a method for forming resin intermediate layers or a protective layer. For this reason, the scope of the present invention is not intended to be limited by the other structures and producing methods thereof.

### <Method for Producing Multi-layered Information Recording Medium>

The following description will discuss a method for producing a multi-layered information recording medium by using the inkjet coating device in accordance with first embodiment of the present invention. In particular, the following description will mainly discuss a method for manufacturing resin intermediate layers constituting the multi-layered information recording medium in detail.

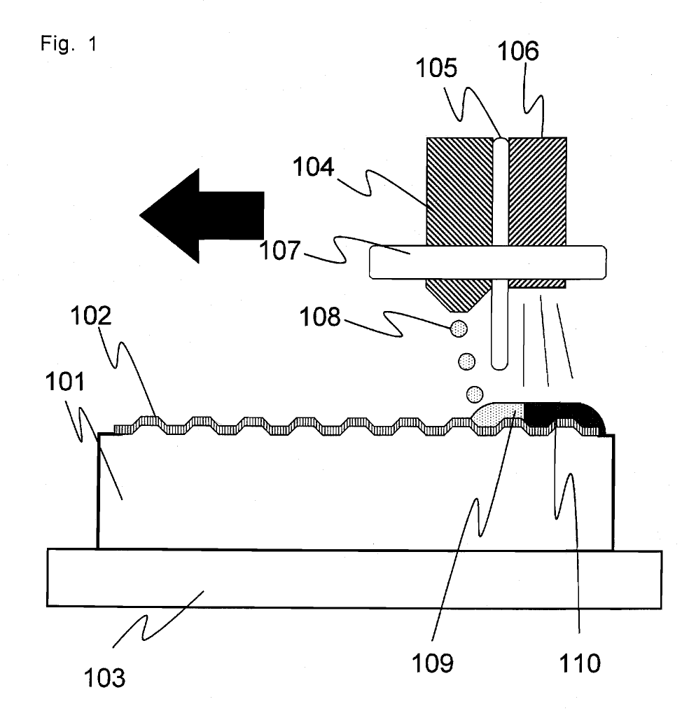

FIG. 1 is a schematic view showing a structure of an inkjet coating device in accordance with the first embodiment of the present invention. FIG. 1 is also a view showing one example of coating and irradiation steps that include an coating process of a radioactive-ray curable resin by use of this inkjet coating device and a curing process through radioactive-ray irradiation. The resin intermediate layers are formed by using these coating and irradiation steps.

### <Structure of Inkjet Coating Device>

As shown in FIG. 1, this inkjet coating device is constituted by an inkjet head 107 and a driving unit (not shown) used for relatively moving the inkjet head 107 in an arrow direction relative to an subject. An inkjet nozzle unit 104 and a radioactive-ray irradiation unit 106 are respectively secured to the inkjet head 107, with a radioactive-ray shielding plate 105 interposed therebetween.

First, the following description will discuss each component member of the inkjet head 107.

At least one or more of inkjet nozzles are provided to the inkjet nozzle unit 104. Those inkjet nozzles used for printing or image-printing printers may be used as the inkjet nozzles. The inkjet nozzle can eject fine ink droplets mainly composed of a pigment, a dye or the like. In the inkjet technique, developments have been made so as to achieve printing steps in which droplets as small as possible, for example, about several pLs, are formed, and by ejecting the droplets with high precision, a printing operation with a higher resolution is carried out. However, in the present invention, since a resin layer having a comparatively high thickness of about 10 to 20 μm needs to be formed, an inkjet nozzle capable of ejecting droplets as large as possible is preferably used. For example, an inkjet nozzle capable of ejecting large droplets of about several ten pLs is preferably used. At present, generally available inkjet nozzles for printers include those having a volume of fine droplet in a range from 5 to 50 pLs, a corresponding viscosity of ejectable resin in a range from 5 to 50 mPa·s in the vicinity of its ejecting portion, and an operational frequency in a range of about 1 kHz to 20 kHz.

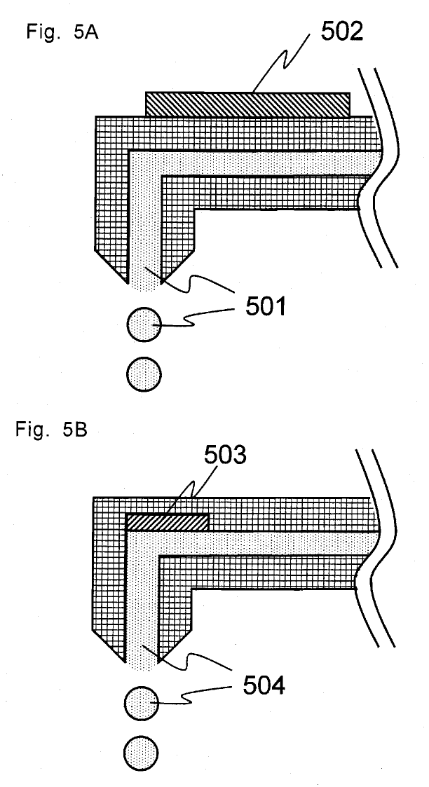

FIGS. 5A and 5B are cross-sectional views showing typical structural examples of the inkjet nozzle. Here, in these drawings, a supply passage of a solution to be ejected, a liquid tank or the like are not given. FIG. 5A shows a type of device in which a solution 501 is pushed out to carry out ejecting operation by using a vibration element 502 such as a piezoelectric element, and this device is referred to as an inkjet nozzle of a piezoelectric system. FIG. 5B shows a type of device in which a solution is instantaneously boiled by using a heater 503 so that an ejecting operation is carried out by using the volume expansion of the solution 504 near the heater as a driving source, and this type is referred to as a thermal system.

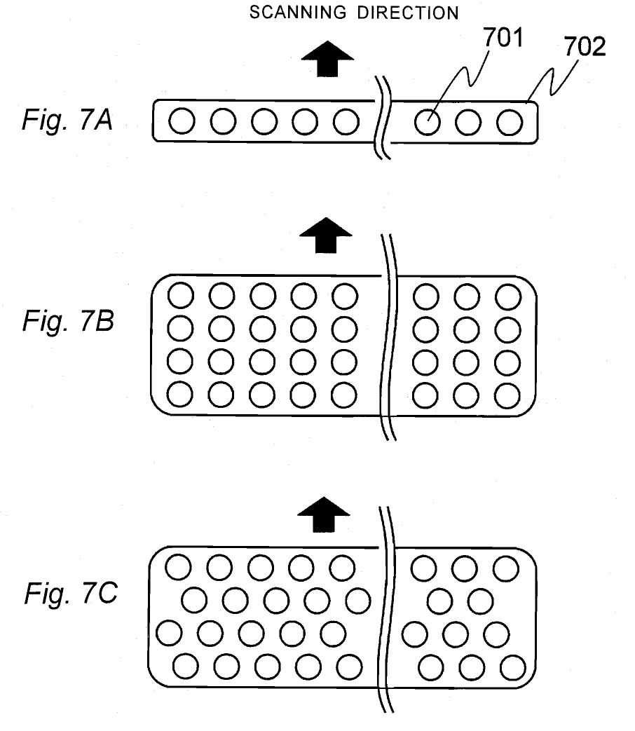

Here, in this case, a description has been given about an inkjet head using a single inkjet nozzle; however, not limited to this, a plurality of inkjet nozzles may be provided. For example, as shown in FIG. 7A, a plurality of inkjet nozzles may be aligned in one row in a direction perpendicular to a scanning direction of the inkjet head so as to form a structure with an inkjet head row. Moreover, there are methods in which as shown in FIG. 7B, a plurality of these rows may be placed side by side in a scanning direction, as shown in FIG. 7C, a plurality of these rows may be placed side by side, with positions of the nozzles being deviated little by little, or the like.

In the inkjet head 107 of first embodiment of the present invention, in order to carry out an coating process over a length of 120 mm that corresponds to the diameter of a molded resin substrate 101 serving a subject at one time, a structure in which at least one row of a plurality of inkjet nozzles is linearly aligned with a width of 120 mm or more in a direction perpendicular to the scanning direction is desirably used.

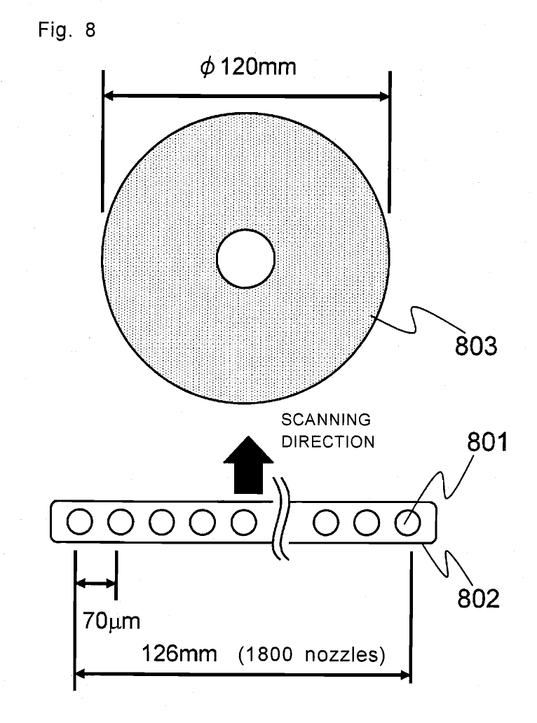

Therefore, the inkjet coating device in first embodiment of the present invention uses an inkjet nozzle having a ejecting amount of one droplet of 40 pLs and a driving frequency of 7 kHz, and an inkjet nozzle unit 802 in which, as shown in FIG. 8, 1800 inkjet nozzles 801 are aligned linearly in a direction perpendicular to the scanning direction with a pitch of 70 μm. This inkjet nozzle makes it possible to eject droplets of a resin, each stably having 40 pLs, as long as the resin has a viscosity in a range from about 5 to 50 mPa·s.

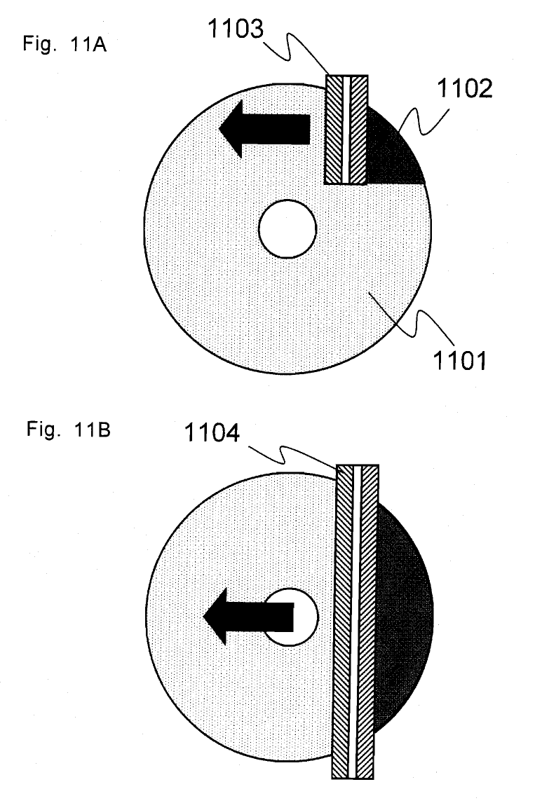

Here, the inkjet nozzle unit as shown in FIG. 8 is used herein; however, an inkjet nozzle unit, as shown in FIG. 11A, may be used. In this case, the inkjet head is moved in a direction perpendicular to a scanning direction, and these scanning steps are carried out on the substrate several times so that the entire surface is coated. In this case, a mechanism that moves the inkjet head in the direction perpendicular to the scanning direction is required.

Here, as shown in FIG. 8 and FIG. 11B, an inkjet nozzle unit having a longer length in the direction perpendicular to the scanning direction of a molded resin substrate serving as a subject, that is, a length longer than the diameter of the substrate, is preferably used. With this structure, the resin can be coated to the entire surface of the substrate by a scanning process at one time.

Next, the following description will discuss a radioactive-ray irradiation unit 106.

The radioactive-ray irradiation unit 106 is constituted by a radioactive-ray source, and a light path that leads radioactive rays generated from the radioactive-ray source to the molded resin substrate 101 serving as the subject. Herein, an ultraviolet-ray lamp is used as the radioactive-ray source. Furthermore, various lamps, such as a metal halide lamp, a high-pressure mercury lamp and a xenon lamp, may be used as the ultraviolet-ray lamp. In this case, a xenon lamp is used. However, it is necessary to properly select a wavelength and the like of a radioactive ray to be irradiated in accordance with a radioactive-ray curable resin to be coated, and the kinds of the radioactive-ray source and the lamp are not intended to be limited by the above examples.

Moreover, as shown in FIG. 1, the radioactive-ray irradiation unit 106 is secured to the rear portion in the scanning direction of the inkjet nozzle unit, together with the inkjet nozzle unit 104 that carries out a scanning process over the molded resin substrate 101 serving as the subject. By using the radioactive-ray irradiation unit 106, the coated radioactive-ray curable resin layer is successively irradiated with radioactive rays.

The radioactive-ray shielding plate 105 prevents the radioactive rays to be coated by the radioactive-ray irradiation unit 106 from leaking toward the inkjet nozzle 104 side. That is, the radioactive-ray shielding plate 105 prevents the radioactive rays emitted from the radioactive-ray irradiation unit from being irradiated prior to the coat of droplets of the radioactive-ray curable resin ejected from the inkjet nozzle.

With the above structure, a radioactive-ray curable resin 109 is coated by the inkjet nozzle unit 104 constituting this inkjet head 107. Then, the coated radioactive-ray curable resin 109 is successively irradiated with radioactive rays by the radioactive-ray irradiation unit 106 placed on the rear side of the inkjet nozzle unit 104 with a predetermined distance. An area 110 irradiated with the radioactive rays of the coated radioactive-ray curable resin is cured so that the flow of the resin is restrained. Here, the area 110 irradiated with the radioactive rays may be completely cured, or may be cured to a semi-cured state without being completely cured so that the flow of the resin can be restrained. The semi-cured state before the completely cured state refers to herein a gel state or a state having a viscosity of 10000 mPa·s or more.

The following description will discuss a driving unit.

The driving unit moves the inkjet head 107 relative to the subject. Therefore, the driving unit may move at least one of the subject and the inkjet head 107. For example, the driving unit may allow the inkjet head 107 to linearly scan the molded resin substrate 101 serving as a subject. Alternatively, the driving unit may allow the inkjet head 107 to scan the molded resin substrate 101 at a constant speed. By carrying out the scanning process at a constant speed in this manner, irradiation of radioactive rays can be carried out after a lapse of a fixed period of time from the coat of the radioactive-ray curable resin. Since irradiation of radioactive rays is carried out after a lapse of a fixed period of time after the coat, the radioactive-ray curable resin can be cured, with its flowing state being set to virtually the same state. For example, the radioactive-ray curable resin can be cured after a so-called leveling phenomenon in which adjacent droplets of the radioactive-ray curable resin are superposed on one another. With this arrangement, the uniformity of the film thickness of the resin intermediate layer can be improved.

<Coating of Radioactive-Ray Curable Resin by Inkjet Coating Device and Irradiation with Radioactive Rays>

The following description will discuss an applying process of a radioactive-ray curable resin by use of the above inkjet coating device and irradiation thereof with radioactive rays.

(a) First, a molded resin substrate 101 with a first information recording layer 102 formed on one of faces thereof is secured onto a stage 103 through vacuum suction. Here, the securing method is not limited to the vacuum suction, and another securing method may also be used. The inkjet head 107 having the inkjet nozzle unit 104 and the radioactive-ray irradiation unit 106 is placed above the molded resin substrate 101. This inkjet nozzle unit 104 is constituted by at least one or more inkjet nozzles. Moreover, a driving unit (not shown), which moves the inkjet head 107 relative to the stage 103 on which the molded resin substrate 101 is secured, is provided. The inkjet head 107 and the driving unit form an inkjet coating device.

Here, in this case, a description is given to a case where, while the stage 103 is secured, an coating process is carried out by moving the inkjet head 107 in parallel therewith; however, not limited to this, the stage 103 and the inkjet head 107 may be moved relative to each other. Moreover, in contrast, the stage 103 may also be moved in parallel therewith, or both of the members may be moved relative to each other.

(b) While the inkjet head 107 is being moved in parallel with the stage 103 relative to each other, fine droplets, made from a radioactive-ray curable resin 108, are dropped onto the molded resin substrate 101 from the inkjet nozzle unit 104. Successively, the radioactive-ray curable resin layer thus coated is sequentially irradiated with radioactive rays by the radioactive-ray irradiation unit 106 placed on the rear side of the inkjet nozzle unit 104 with a predetermined distance.

By using the above steps, the radioactive-ray curable resin is coated and irradiated with radioactive rays.

### <Conditions in Inkjet Coating Device>

Next, the following description will examine each condition in the inkjet coating device.

By using this inkjet head 107, three kinds of radioactive-ray curable resins having different viscosities were coated and irradiated with radioactive rays. In this case, the scanning speed of the inkjet head relative to the molded resin substrate was fixed to 0.5 m/s, and the coat was carried out with a distance between the inkjet nozzle unit and the radioactive-ray irradiation unit being set in a distance between 20 mm to 150 mm. With respect to the irradiation of radioactive rays, irradiation of ultraviolet rays was carried out with the illuminance being set to about 200 mJ/cm². The results are shown in the following Table 1. Here, the resin is not completely cured by the illuminance in the above irradiation with the radioactive rays, however, the illuminance is set to a level that can restrain the flow of the resin itself to a certain degree.

In the respective conditions, the average value of the thickness of the resin layer after the coat, in-plane thickness deviations and degree of protruded resin in the inner edge portion or the outer edge portion of the coating area were confirmed. Here, with respect to the deviations in the coat thickness, the reference value for the determination on the presence or absence thereof was set to ±2 μm.

Moreover, the period of time, required up to the sequential irradiation of the coated radioactive-ray curable resin with radioactive rays from the radioactive-ray irradiation unit of the inkjet head after the coat of the radioactive-ray curable resin from the inkjet nozzle unit of the inkjet head, was calculated. This “period of time up to the irradiation after the coat” was calculated as a value obtained by dividing “distance between the nozzle and the radioactive-ray irradiation unit” by “scanning speed”.

TABLE 1

| | | Distance between nozzle | Scanning | Coat thickness | Deviations in | | Time required up |
|---|---|---|---|---|---|---|---|
| | Viscosity | and radioactive-ray | speed | (in-plane | thickness 0-p | Resin | to irradiation |
| Resin | (mPa · s) | irradiation unit (mm) | (m/s) | average)(μm) | (μm) | protrusion | after coat (sec) |
| A | 5 | 20 | 0.5 | 7.8 | 1.6 ∘ | ∘ | 0.04 |
| | | 50 | 0.5 | 7.7 | 1.5 ∘ | ∘ | 0.10 |
| | | 100 | 0.5 | 7.5 | 2.0 ∘ | ∘ | 0.20 |
| | | 120 | 0.5 | 7.7 | 1.9 ∘ | ∘ | 0.24 |
| | | 150 | 0.5 | 5.1 | 2.5 x | x | 0.30 |
| B | 20 | 20 | 0.5 | 7.9 | 0.8 ∘ | ∘ | 0.04 |
| | | 50 | 0.5 | 8.1 | 1.1 ∘ | ∘ | 0.10 |
| | | 100 | 0.5 | 7.9 | 2.0 ∘ | ∘ | 0.20 |
| | | 120 | 0.5 | 7.7 | 1.8 ∘ | ∘ | 0.24 |
| | | 150 | 0.5 | 7.5 | 2.8 x | Partially NG | 0.30 |
| | | | | | | Δ | |
| C | 50 | 20 | 0.5 | 8.2 | 0.8 ∘ | ∘ | 0.04 |
| | | 50 | 0.5 | 7.9 | 1.1 ∘ | ∘ | 0.10 |
| | | 100 | 0.5 | 7.9 | 1.5 ∘ | ∘ | 0.20 |
| | | 120 | 0.5 | 7.9 | 1.5 ∘ | ∘ | 0.24 |
| | | 150 | 0.5 | 8.1 | 2.1 x | Partially NG | 0.30 |
| | | | | | | Δ | |

From the results shown in Table 1, it was confirmed in the resin A with a resin viscosity of 5 mPa·s that, under the condition of 150 mm in the distance between the inkjet nozzle unit and the radioactive-ray irradiation unit, protruded portions of the coated resin appeared in both of the inner edge portion and the outer edge portion of the coating area. Moreover, under the condition of 120 mm or less in the distance between the inkjet nozzle unit and the radioactive-ray irradiation unit, no problem was raised with respect to the thickness deviations and the resin protruded portions.

In the resin B with a resin viscosity of 20 mPa·s, under the condition of 120 mm or less in the distance between the inkjet nozzle unit and the radioactive-ray irradiation unit, the in-plane thickness deviations were kept within the reference value, and no resin protrusion was confirmed. Under the condition of 150 mm in the distance between the inkjet nozzle unit and the radioactive-ray irradiation unit, the thickness deviations exceeded the reference value, and a resin protrusion was confirmed at one portion of the outer edge portion of the coating area.

In the resin C with a resin viscosity of 50 mPa·s, under the condition of 120 mm or less in the distance between the inkjet nozzle unit and the radioactive-ray irradiation unit, the thickness deviations were kept within the reference value, and no resin protrusion was confirmed. Under the condition of 150 mm in the distance between the inkjet nozzle unit and the radioactive-ray irradiation unit, although a resin protrusion was confirmed at one portion of the outer edge portion, hardly any problems were raised in the other aspects.

It was confirmed from the above results that in the resin viscosity range capable of being ejected by the inkjet nozzle from 5 mPa·s to 50 mPa·s, by setting the distance between the inkjet nozzle unit and the radioactive-ray irradiation unit to 120 mm or less, the coat of the resin layer could be carried out uniformly. Furthermore, by setting the distance between the inkjet nozzle unit and the radioactive-ray coating unit to 50 mm or less, it becomes possible to desirably improve the quality.

### <Concerning the Distance Between the Inkjet Nozzle Unit and the Radioactive-Ray Irradiation Unit>

This inkjet coating device is characterized in that the inkjet nozzle unit and the radioactive-ray irradiation unit are provided in the inkjet head spaced from each other with a predetermined distance. That is, after the coat of the radioactive-ray curable resin, the resin can be cured by sequential irradiating steps with radioactive rays. In this case, the droplets of the coated radioactive-ray curable resin are allowed to flow to be superposed on adjacent droplets, that is, subjected to a so-called leveling phenomenon, and then further flow to spread so that thereafter, the thickness thereof is gradually reduced. In this inkjet coating device, however, after the droplets have been leveled after the coat, they are successively irradiated with radioactive rays to be cured. For this reason, the period of time, required up to the irradiation with radioactive rays after the coat of the radioactive-ray curable resin, becomes essential.

Therefore, the following description will examine “the period of time required up to the irradiation after the coat.”

(a) First, it is supposed that the distance from the lower end of the inkjet nozzle to the surface of the molded resin substrate serving as an subject is WD (m), that is, a working distance, and that the ejecting speed of the radioactive-ray curable resin is V (m/s). Here, the working distance WD (m) is approximately given by:

0.001 (m)≦WD≦0.01 (m).

Moreover, the ejecting speed V (m/s) of the radioactive-ray curable resin is approximately given by:

1 (m/s)≦V≦6 (m/s)

when the viscosity is set in a range from 5 to 50 (mPa·s).
(b) From the working distance WD and the ejecting speed V, the following equation is obtained:

Ti=WD/V (s).

The above Ti(s) represents the period of time from the ejecting of the radioactive-ray curable resin to the adhesion thereof to the subject. Furthermore, by using the above working distance WD and the range of the ejecting speed V, the period of time Ti up to the adhesion is given by:

0.00017 (s)≦Ti≦0.01 (s).

(c) Next, the period of time Tl from the start of flowing of the radioactive-ray curable resin to the leveling is about 0.01 (s) although this period is depending on the physical properties of the radioactive-ray curable resin.
(d) After the leveling of the radioactive-ray curable resin, the following period is required so as to cure the resulting resin by irradiation with the radioactive rays:

0.01017 (s)≦Ti+Tl≦0.02 (s).

(d) In the case where the period of time up to the occurrence of leveling is used as the period of time required up to the irradiation with radioactive rays after the coat of the radioactive-ray curable resin, the following estimation is obtained:

0.01 (s)≦(time up to irradiation after the coat)≦0.02 (s)

That is, the lower limit value of “the period of time required up to the irradiation after the coat” can be estimated to be about 0.01 sec.

Furthermore, with respect to the upper limit value of “the period of time required up to the irradiation after the coat”, referring to Table 1, it is found that the period of time up to about 0.24 sec is permissible. Therefore, from the results of the examples, the upper limit value of “the period of time required up to the irradiation after the coat” can be estimated to be 0.25 sec.

From the results described above, “the period of time required up to the irradiation after the coat” is preferably set in a range from 0.01 sec to 0.25 sec.

### <Scanning Speed of the Inkjet Head Relative to the Molded Resin Substrate>

From the results shown above, it is confirmed that a uniform resin layer can be formed; however, since the thicknesses of the resin intermediate layers in first embodiment of the present invention need to be formed within a range from 10 μm to 20 μm, the coating should be carried out so as to make the coat thickness thicker. Therefore, in the case where the distance between the inkjet nozzle and the radioactive-ray irradiation unit is set to 50 mm by using the resin B having a resin viscosity of 20 mPa·s, the results, obtained when the scanning speed of the inkjet head relative to the molded resin substrate was changed, are shown in the following table 2. Table 2 shows the change in the coat thickness, the thickness deviations, the resin protrusions and the period of time required up to irradiation after the coat.

TABLE 2

| | | Distance between nozzle | Scanning | Coat thickness | Deviations in | | Time required up |
|---|---|---|---|---|---|---|---|
| | Viscosity | and radioactive-ray | speed | (in-plane | thickness 0-p | Resin | to irradiation |
| Resin | (mPa · s) | irradiation unit (mm) | (m/s) | average)(μm) | (μm) | protrusion | after coat (sec) |
| B | 20 | 50 | 0.5 | 8.1 | 1.1 ∘ | ∘ | 0.10 |
| | | 50 | 0.4 | 9.8 | 1.0 ∘ | ∘ | 0.13 |
| | | 50 | 0.3 | 13.6 | 1.5 ∘ | ∘ | 0.17 |
| | | 50 | 0.2 | 19.3 | 1.4 ∘ | ∘ | 0.25 |

As the scanning speed relative to the molded resin substrate of the inkjet head is made slower, fine droplets that have been dropped are coated onto the molded resin substrate in a manner so as to be superposed one after another. Moreover, the total amount of the resin to be dropped is inversely proportional to the scanning speed. It is also confirmed from the results shown in Table 2 that the coat thickness is increased virtually inversely proportional to the scanning speed. Moreover, no involvements of bubbles or like are seen.

In this manner, by appropriately changing the scanning speed of the inkjet head relative to the molded resin substrate, without changing the structure of the inkjet head, it is possible to control the thickness to a certain degree. For this reason, by finely adjusting this scanning speed in accordance with designed thicknesses of the first resin intermediate layer, the second resin intermediate layer and the third resin intermediate layer, it is possible to achieve a desired thickness of each resin intermediate layer.

Moreover, since, after the coat of the radioactive-ray curable resin by the inkjet coating device, the transferring step of the information face of the transfer stamper is successively carried out, the dose of the radioactive rays used upon coat of the radioactive-ray curable resin needs to be set to a dose smaller than the dose of the radioactive rays used for completely curing the resin. Herein, the radioactive-ray illuminance of the radioactive-ray irradiation unit was set to about 200 mJ/cm². It was confirmed that, under this condition, a slight adhesive property remains on the surface of the radioactive-ray curable resin layer after the coat. Moreover, by using transferring step of the information face of the transfer stamper described with reference to FIGS. 10A to 10D, groove transferring processes were carried out, and the groove depth of the transferred radioactive-ray curable resin layer was about 97% relative to the original groove depth of the stamper. This value is sufficient so as to provide a transferring property.

### <Another Structural Example of Inkjet Coating Device>

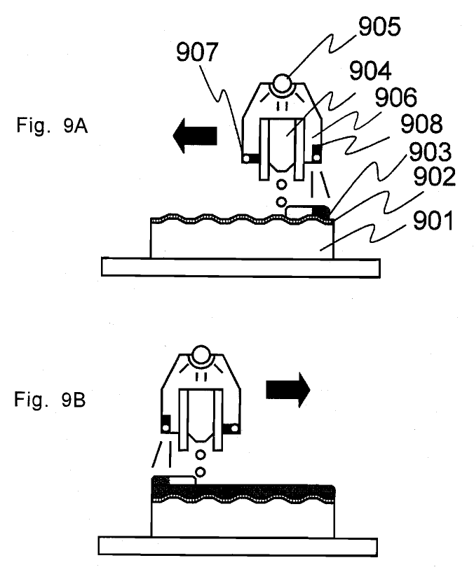

Next, referring to FIGS. 9A and 9B, the description will discuss another structural example of an inkjet coating device in accordance with first embodiment of the present invention. FIGS. 9A and 9B are schematic views showing a structure of an inkjet head that has respective radioactive-ray irradiation unit on the front side and the rear side in the moving direction of the inkjet head relative to the subject. Here, with respect to the inkjet nozzle unit, one having the same structure as showing in FIG. 8 may be used. By using this inkjet head, stacking and coating steps are carried out a plurality of times so that a thickness in a range from 10 μm to 20 μm can be achieved.

As shown in FIGS. 9A and 9B, this inkjet head is provided with an inkjet nozzle unit 904 and radioactive-ray irradiation unit 906 that are attached to the front side and the rear side relative to the scanning direction of the inkjet nozzle unit. The respective radioactive-ray irradiation unit 906, which have respectively branched paths that lead radioactive rays emitted from a radioactive-ray lamp 905 serving as a light source to the molded resin substrate 901 side, are disposed on the front side and the rear side relative to the scanning direction of the inkjet nozzle unit. Moreover, shutters 907 and 908 are respectively provided to the two emitting outlets of the respective radioactive-ray irradiation unit 906. In accordance with this inkjet head, since the radioactive-ray irradiation unit are disposed on the front and rear sides of the inkjet nozzle unit, it is not necessary to rotate the inkjet head itself, even when, upon carrying out a scanning process linearly, the scanning direction is inverted.

At first, upon carrying out the first coating process (see FIG. 9A), the shutter 907 of the radioactive-ray irradiation unit on the front side in the advancing direction of the inkjet nozzle unit is closed, while, in contrast, the shutter 908 on the rear side is opened, so that only the radioactive-ray irradiation unit on the rear side relative to the scanning direction of the inkjet nozzle is made effective. Thus, after the first coating and irradiation steps have been carried out, the inkjet head is allowed to scan the molded resin substrate in a direction reversed to that of the preceding operation (FIG. 9B). At this time, in the radioactive-ray irradiation unit, the shutter 908 on the front side in the scanning direction is closed, while the shutter 907 on the rear side is opened, so that only the radioactive-ray irradiation unit on the rear side relative to the scanning direction of the inkjet nozzle is made effective. By repeating these operations, stacking and coating processes of several times can be carried out.

Table 3 shows the resulting coat thicknesses in the case where, by using the resin B having a resin viscosity of 20 mPa·s, each of the distances between the inkjet nozzle unit and the radioactive-ray irradiation unit placed on the front and rear sides thereof is set to 50 mm.

TABLE 3

| | | Distance between nozzle | Scanning | Scanning times | Coat thickness | Deviations in | |
|---|---|---|---|---|---|---|---|
| | Viscosity | and radioactive-ray | speed | (number of | (in-plane | thickness 0-p | Resin |
| Resin | (mPa · s) | irradiation unit (mm) | (m/s) | times) | average)(μm) | (μm) | protrusion |
| B | 20 | 50 | 0.5 | 1 | 7.9 | 0.9 ∘ | ∘ |
| | | 50 | 0.5 | 2 | 15.4 | 1.6 ∘ | ∘ |
| | | 50 | 0.5 | 3 | 22.9 | 1.9 ∘ | ∘ |

From the results shown in Table 3, it was confirmed that it is possible to make the coat thickness thicker virtually in proportion to the corresponding number of stacked layers. Moreover, none of mingled air bubbles and protrusions of the resin in the inner edge portion and the outer edge portion of the coating area were observed. Moreover, with respect to the thickness distribution, deviations tend to increase as the number of the scanning steps increases because the stacking and coating are carried out. However, by carrying out the coating under these conditions, the coating steps with a thickness in a range from 8 μm to 23 μm can be achieved without causing any problems.

Moreover, in this case, experiments were carried out, with the dose of radioactive rays in the radioactive-ray irradiation unit being set to a constant value of 200 mJ/cm² in all the scanning steps; however, upon taking into consideration of the groove-transferring steps after the coat of the resin layer, it is preferable to adjust the dose of the radioactive rays at least in the last coating and irradiation steps so as to form a state in which the radioactive-ray curable resin is not completely cured, in the case where a plurality of coating and irradiation steps are repeated in this manner.

For example, there is a method such as in the case where the scanning processes of three times are carried out, in the first and second coating and irradiation steps, the dose of radioactive rays is set to 1000 mJ/cm² so that the radioactive-ray curable resin is virtually completely cured. In contrast, in the last third coating and irradiation steps, the dose is set to 200 mJ/cm² so as not to completely cure the radioactive-ray curable resin so that the groove-transferring process can be easily executed. Moreover, the dose of the radioactive-ray irradiation is easily increased and reduced by adjusting the aperture ratio of the shutter attached to the radioactive-ray emitting outlet.

Moreover, for example, in the case where the coating and irradiation steps of three times are carried out by using scanning steps of three times, in the first and second coating and irradiation steps, the dose of radioactive rays is set to 1000 mJ/cm² so that the radioactive-ray curable resin is virtually completely cured. In contrast, in the last third coating and irradiation steps, the dose is set to 0 mJ/cm², that is, no irradiation of the radioactive rays is given. In this case, since the outermost surface of the radioactive-ray curable resin is left uncured, the groove-transferring process can be easily executed. Also in this case, it becomes possible to obtain the same effects as those of the above method.

Moreover, a plurality of kinds of resins may be coated by carrying out a plurality of coating and irradiation steps.

For example, a resin E that exerts good adhesive property to the molded resin substrate or the first information recording layer and a resin F that exerts good peeling property to the transfer stamper were used for carrying out stacking and coating steps. This layer structure is preferably used because the succeeding groove transfer process is easily carried out. The results of the coating processes in this case are shown in Table 4.

TABLE 4

| | | | Distance between nozzle | Scanning | Coat thickness | Deviations in |
|---|---|---|---|---|---|---|
| Number of | | Viscosity | and radioactive-ray | speed | (in-plane | thickness 0-p |
| scanning steps | Resin | (mPa · s) | irradiation unit (mm) | (m/s) | average)(μm) | (μm) |
| First time | E | 20 | 50 | 0.5 | 8.2 | 1.1 ∘ |
| Second time | E | 20 | 50 | 0.5 | 15.8 | 1.5 ∘ |
| Third time | F | 15 | 50 | 0.5 | 23.1 | 1.9 ∘ |

From the above results, it was confirmed that, even when two kinds of resins are used as radioactive-ray curable resins, it is possible to increase the thickness virtually in proportion to the corresponding number of coating processes. Moreover, among the coating and irradiation steps of a plurality of times, in the last coating and irradiation steps of the resin F, the coating may be carried out, with the dose of the radioactive-ray irradiation being lowered so as not to completely cure the resin. It is preferable to provide such a state as not to completely cure the resin because the succeeding groove transferring property is desirably carried out. Moreover, in the coating and irradiation steps of the resin F, the dose of radioactive rays may be set to 0 mJ/cm², that is, no radioactive rays may be coated; thus, the same effects as described above can be obtained.

Moreover, manufacturing steps of the first resin intermediate layer have been discussed herein; however, not limited to this, the manufacturing steps may also be coated to the second resin intermediate layer and the third intermediate layer. Also in this case, the effects of the present invention are effectively exerted, and the effects can be exerted in the manufacturing steps of all the resin intermediate layers.

### Second Embodiment

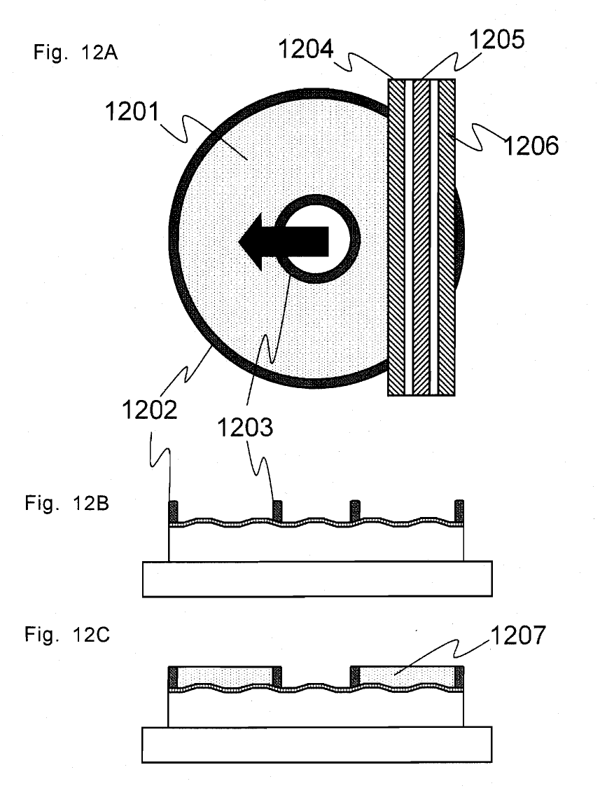

With referring to FIGS. 12A to 12C, the description will discuss manufacturing steps of a resin intermediate layer in a method for producing a multi-layered information recording medium in accordance with second embodiment of the present invention. In comparison with the producing method of a multi-layered information recording medium relating to first embodiment, this method for producing a multi-layered information recording medium is characterized in that in the manufacturing steps of the resin intermediate layer, the method includes the steps of:

(a) forming wall portions made of a radioactive-ray curable resin on an inner circumferential portion and an outer circumferential portion that surround an area in which a resin intermediate layer is formed; and
(b) applying a radioactive-ray curable resin to the area surrounded by the wall portions of the inner circumferential portion and the outer circumferential portion, and after the coat, successively carrying out the irradiation of radioactive rays.

Here, the steps other than the coating and irradiation steps of the resin intermediate layer are virtually the same as each step described in first embodiment; therefore, the description thereof will not given. Moreover, the effects of the present invention are derived from the manufacturing processes of the resin intermediate layer, and even if any steps may be used in the other steps, the effects of the present invention are not limited thereby.

FIGS. 12A to 12C show a method for manufacturing a resin intermediate layer in accordance with second embodiment of the present invention. Here, the structure of an inkjet head to be used is formed into the same structure as shown in FIGS. 9A and 9B) in the first embodiment.

(a) By using the above inkjet head, coating and irradiation steps of a radioactive-ray curable resin are carried out on a portion surrounded into a ring shape, with respect to the inner circumferential portion and the outer circumferential portion of the coating area of the resin intermediate layer formed on the molded resin substrate 1201 (FIG. 12A). Here, the structure of the ring-shaped wall faces 1202 and 1203 can be achieved by adjusting the scanning speed of the inkjet head, or by carrying out stacking and coating of a plurality of times, so as to provide a desired thickness in the coating area. In the case where the inkjet head structure of the first embodiment is used, since the resin can be cured prior to the occurrence of its flowing, it is possible to manufacture wall faces having a uniform thickness.
(b) Thereafter, the radioactive-ray curable resin is ejected into the area surrounded by the wall face 1202 of the outer circumferential portion and the wall face 1203 of the inner circumferential portion so that a resin intermediate layer having a uniform thickness corresponding to the height of the wall faces can be formed.

Table 5 shows the results of measurements on the thickness of the resin intermediate layer formed by this method.

TABLE 5

| | | | Distance between nozzle | Scanning | Coat thickness | Deviations in |
|---|---|---|---|---|---|---|
| Number of | | Viscosity | and radioactive-ray | speed | (in-plane | thickness 0-p |
| scanning steps | Resin | (mPa · s) | irradiation unit (mm) | (m/s) | average)(μm) | (μm) |
| First time (wall face) | B | 20 | 50 | 0.5 | 8.1 | 0.8 ∘ |
| Second time (wall face) | B | 20 | 50 | 0.5 | 15.4 | 1.2 ∘ |
| Third time (entire | B | 20 | 50 | 0.3 | 15.5 | 1.5 ∘ |
| coating area) | | | | | | |

By using a resin having a viscosity of 20 mPa·s as the resin, coating steps were carried out on the wall faces by scanning thereon at a scanning speed of 0.5 m/s two times. The width of the wall face was about 200 μm, and the target thickness was about 15 μm. Moreover, the irradiation of radioactive rays was set to 1000 mJ/cm². Furthermore, in the third time, the resin was coated to the entire coating area at a scanning speed of 0.3 m/s. In the third resin coat, no irradiation of radioactive rays was carried out.

Normally, in the case where a resin having a resin viscosity of 20 mPa·s is coated with a thickness of 15 μm, a projected portion occurs on the outer circumferential edge face due to the flowing of the resin, with the result that large variations appear in the in-plane thickness distribution. However, in second embodiment, even in a state where no irradiation of radioactive rays was carried out, it was possible to obtain good thickness distribution with in-plane deviations of ±1.5 μm as shown in Table 5.

In this case, experiments were carried out by using only the resin having a viscosity of 20 mPa·s; however, the coat thickness can be controlled within a viscosity range capable of being ejected by the inkjet nozzle as carried out in the first embodiment, and the same is also true in the second embodiment of the present invention.

Moreover, only the manufacturing processes of the first resin intermediate layer have been described; however, the present invention is effectively coated to manufacturing steps for the other resin intermediate layers. Moreover, the present invention is also applicable to the forming steps of the protective layer.

The inkjet coating device of the present invention is useful as a technique for a multi-layered medium, such as a multi-layered information recording medium. In particular, the device is utilized for a resin-layer stacking process for a Blu-ray disc or the like.

1. An inkjet coating device, which coats a radioactive-ray curable resin to a subject, while moving either the subject or an inkjet head relative to the other, comprising:
an inkjet head provided with an inkjet unit having:
an inkjet nozzle for ejecting droplets of the radioactive-ray curable resin; and
a radioactive-ray irradiation unit which is placed on the rear side of the inkjet unit in a moving direction relative to the subject so as to be spaced therefrom with a predetermined distance, and irradiates the radioactive-ray curable resin coated onto the subject with radioactive rays; and
a driving unit which moves the inkjet head relative to the subject.

2. The inkjet coating device according to claim 1, wherein the driving unit moves the inkjet head at a constant speed relative to the subject so that, after a predetermined period of time after the coat, the radioactive-ray curable resin coated to the subject from the inkjet nozzle is sequentially irradiated with radioactive rays from the radioactive-ray irradiation unit

3. The inkjet coating device according to claim 2, wherein the driving unit moves the inkjet head in a linear direction relative to the subject.

4. The inkjet coating device according to claim 1, wherein the inkjet head is further provided with a radioactive-ray shielding plate interposed between the inkjet nozzle unit and the radioactive-ray irradiation unit so that the radioactive-ray shielding plate prevents radioactive rays emitted from the radioactive-ray irradiation unit from being irradiated before droplets of the radioactive-ray curable resin ejected from the inkjet nozzle are coated.

5. The inkjet coating device according to claim 1, wherein the inkjet head is provided with a first radioactive-ray irradiation unit and a second radioactive-ray irradiation unit which are placed on the front side and rear side in a relative moving direction, while the inkjet unit is interposed therebetween, with a predetermined distance apart from the inkjet unit.

6. The inkjet coating device according to claim 5, wherein the driving unit moves the inkjet head reciprocatingly in a linear direction relative to the subject, and upon inverting the relative moving direction, the inkjet head makes a switch from the first radioactive-ray irradiation unit to the second radioactive-ray irradiation unit so as to be irradiated with radioactive rays.

7. The inkjet coating device according to claim 1, wherein the inkjet head has a structure in which a plurality of inkjet nozzles are disposed on the inkjet nozzle unit over not less than the width of the subject in a direction perpendicular to the relative moving direction.

8. A method for producing a multi-layered information recording medium having a substrate, a plurality of information recording layers placed on the substrate, a resin intermediate layer disposed between the information recording layers and a protective layer formed on the information recording layer,
wherein by using an inkjet coating device comprising an inkjet head provided with an inkjet unit having an inkjet nozzle for ejecting droplets of a radioactive-ray curable resin and a radioactive-ray irradiation unit which is placed on the rear side of the inkjet unit in a moving direction relative to a subject so as to be spaced therefrom with a predetermined distance, and irradiates the radioactive-ray curable resin coated onto the subject with radioactive rays, the method comprises coat and irradiation steps in which the radioactive-ray curable resin is dropped from the inkjet unit onto the subject, while being moved relative to the subject, and the radioactive-ray curable resin is then sequentially irradiated with radioactive rays from the radioactive-ray irradiation unit so that resin intermediate layers are formed on the subject.

9. The method for producing a multi-layered information recording medium according to claim 8, wherein in the coat and irradiation steps, the subject is a substrate provided with an information recording layer, and the method further comprises a transfer step in which an information face is transferred to be formed onto the surface of the radioactive-ray curable resin formed on the substrate.

10. The method for producing a multi-layered information recording medium according to claim 8, wherein in the coat and irradiation steps, the subject is a transfer stamper, and the method further comprises:
superposing the transfer stamper on the substrate with the radioactive-ray curable resin interposed therebetween; and
peeling the transfer stamper from the radioactive-ray curable resin.

11. The method for producing a multi-layered information recording medium according to claim 8, wherein the coat and irradiation steps include:
forming wall faces of an inner edge portion and an outer edge portion surrounding an area in which a resin intermediate layer having a predetermined coat thickness and made of a radioactive-ray curable resin is formed while a radioactive-ray curable resin is irradiated with radioactive rays after dropping the radioactive-ray curable resin onto the inner edge portion in a radial direction and the outer edge portion in the radial direction; and
forming the resin intermediate layer by irradiating the radioactive-ray curable resin with radioactive rays after dropping the radioactive-ray curable resin onto the area surrounded by the wall faces of the inner edge portion and the outer edge portion.

12. The method for producing a multi-layered information recording medium according to claim 8, wherein in the coat and irradiation steps, the inkjet coating device is moved at a constant speed relative to the subject so that after a lapse of a predetermined period of time from the coating of the radioactive-ray curable resin, the radioactive-ray curable resin is irradiated with radioactive ray.

13. The method for producing a multi-layered information recording medium according to claim 8, wherein the coat and irradiation steps are carried out a plurality of times.

14. The method for producing a multi-layered information recording medium according to claim 13, wherein in the last step among the coat and irradiation steps of a plurality of times, the dose of the radioactive-ray irradiation is made smaller in comparison with the dose in the preceding coat and irradiation steps.

15. The method for producing a multi-layered information recording medium according to claim 13, wherein in the last step among the coat and irradiation steps of a plurality of times, only the coat of the radioactive-ray curable resin is carried out.

16. The method for producing a multi-layered information recording medium according to claim 11, wherein in the coat and irradiation steps, a plurality of kinds of resins are used as the radioactive-ray curable resin.

17. A multi-layered information recording medium manufactured by using the method for manufacturing a multi-layered information recording medium according to claim 8.

18. The multi-layered information recording medium according to claim 17, wherein the multi-layered information recording medium has the resin intermediate layer whose edge face has a zig-zag shape caused by the droplets ejected from the inkjet nozzle.
